(19) United States
(12) Patent Application Publication
(10) Pub. No.: US 2025/0328642 A1
(43) Pub. Date: Oct. 23, 2025

(54) MACHINE LEARNING-BASED CONTENT DISARM AND RECONSTRUCTION WITH WEB BROWSER PREFETCHING

(71) Applicant: Palo Alto Networks, Inc., Santa Clara, CA (US)

(72) Inventors: Chao Huang, Menlo Park, CA (US); Lei Xu, Sunnyvale, CA (US); Runzhen Wang, Campbell, CA (US); Lexuan Sun, Sunnyvale, CA (US); Yu Fu, Sunnyvale, CA (US); Chien-Hua Lu, San Jose, CA (US)

(21) Appl. No.: 18/638,388

(22) Filed: Apr. 17, 2024

(51) Int. Cl. G06F 21/56

(52) U.S. Cl. CPC G06F 21/563; G06F 2221/033

(57) ABSTRACT

A web page content disarm and reconstruction (“CDR”) service (“service”) intercepts user requests for a web page via a web browser and prefetches source code for the web page and any web pages hyperlinked therein. The service generates features from sections of source code of the web page and hyperlinked web pages. Classifiers then classify the features to obtain malicious/benign verdicts of corresponding sections of source code as output. The service applies criteria to malicious verdicts to determine whether to disable hyperlinks in the web page, remove malicious code for the web page, and/or block the web page. Once a corresponding action has been taken for source code of the web page, the service reconstructs the source code and communicates the reconstructed code to the web browser for rendering.

### BACKGROUND

The disclosure generally relates to transmission of digital information (e.g., CPC class H04L) and network arrangements, protocols or services for addressing or naming (e.g., subclass H04L 61/00).

Link prefetching is a technique for retrieving data at resources (i.e., web pages) that a user is likely to access prior to the user accessing those resources. Prefetched data can be stored in a cache, e.g., a web browser cache for efficient retrieval when the user attempts to access a resource. Examples of data that can be stored in the cache include HyperText Markup Language (HTML) documents, JavaScript® code, Cascading Style Sheets (CSS) code, HyperText Transfer Protocol (HTTP) response headers, etc. Prefetching can occur as a background process by a web browser running while the user is browsing the Internet.

Content disarm & reconstruction (CDR) is a technique for intercepting potentially malicious files, removing potentially malicious code from the intercepted files, and reconstructing the files with the code removed before forwarding the reconstructed files to their intended destinations. CDR can be applied to files from various data sources such as emails, public to private network communications, etc., and to files of various formats such as image files, Portable Document Format (PDF) files, etc. Reconstruction techniques depend on formats of the files and involve reconstructing files in such a way that each file maintains a valid format post reconstruction.

### BRIEF DESCRIPTION OF THE DRAWINGS

Embodiments of the disclosure may be better understood by referencing the accompanying drawings.

FIG. 1 is a schematic diagram of an example system for prefetching web page data for CDR prior to rendering web pages to a user.

FIG. 2 is an illustrative diagram of example web page renders after a web browser CDR service (“service”) performs a disarm action.

FIG. 3 is a flowchart of example operations for CDR of malicious web page source code with machine learning and prefetching.

FIG. 4 is a flowchart of example operations for determining and performing a security/disarm action(s) based on a corresponding malicious verdict(s).

FIG. 5 depicts an example computer system with a web browser CDR service and source code classifiers.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

Web browser attacks such as injection attacks of malicious JavaScript code can occur the instant a web browser renders a web page and executes code therein. An injection attack can exploit CPU resources while a user views a web page; however, the web page may contain useful information to the user despite the additional malicious code contained therein. As such, the present disclosure presents a methodology for selectively removing/blocking malicious code and hyperlinks in web pages while still allowing a user to access potentially useful content from the web pages. A web browser CDR service (“service”) or other module interfacing with a web browser intercepts user requests to access a web page corresponding to a Uniform Resource Locator (URL). The service then prefetches data in HTTP responses from a web server for the web page and prefetches data in HTTP responses for hyperlinks in the web page.

Prior to sending the HTTP responses to the web browser for rendering, the service generates various feature vectors from data in the HTTP responses for malicious classification. Each feature vector corresponds to a distinct section of the web page/hyperlinked web pages or section of code that executes when rendering the web page/hyperlinked web pages. The service then feeds the feature vectors into classifiers that predict whether each feature vector corresponds to malicious content/code. The service applies criteria to any malicious verdict(s) output by the classifiers to determine whether to disable hyperlinks, remove malicious content/code, disable hyperlinks and remove malicious content/code, or block the entire web page. If there are sufficiently many malicious verdicts and/or the malicious verdicts have sufficient severity, the service blocks the web page entirely. For each malicious verdict corresponding to a hyperlink HTML element or to malicious content/code in a hyperlinked web page, the service disables those hyperlinks, e.g., by removing a corresponding hyperlink HTML element. For each malicious verdict that does not correspond to a hyperlink or malicious content/code in a hyperlinked web page, the service removes the malicious content/code from the HTTP response for the web page.

When hyperlinks are disabled and/or malicious content/code is removed, the service reconstructs the remainder of the web page along with adding indications of what was removed/disabled and corresponding metadata for the malicious attack. Prefetching web page data for CDR prior to rendering the web page to the user avoids execution of malicious code while still allowing the user to view content on the web page and promotes safer user behavior and reduced exposure to malicious cyberattacks. Moreover, the service maintains a cache of data/verdicts for previously reconstructed web pages and previously classified hyperlink web pages for efficient subsequent malicious content removal, disabling of hyperlinks, and web page blocking.

### Example Illustrations

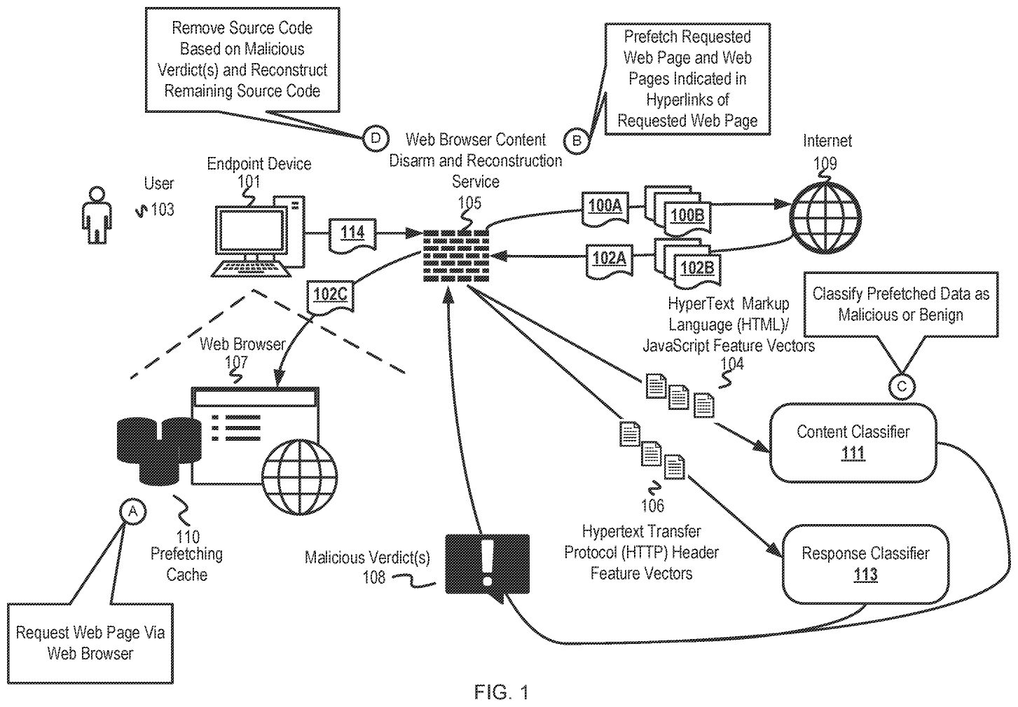

FIG. 1 is a schematic diagram of an example system for prefetching web page data for CDR prior to rendering web pages to a user. A web browser CDR service (“service”) 105 for a web browser 107 on an endpoint device 101 of a user 103 acts as a middleman between the web browser 107 and the Internet 109 to prefetch and clean web page data prior to rendering the web page data in the web browser 107. The service 105 uses a content classifier 111 and a response classifier 113 to detect, from the web page data, malicious code/content. Based on malicious verdicts for sections of code/content, the service 105 can choose to remove malicious code/content, disable hyperlinks, and/or block entire web pages. FIG. 1 is annotated with a series of letters A-D. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, the user 103 requests a web page via the web browser 107. For instance, the user 103 can enter a URL into a search bar in a user interface (UI) of the web browser 107 at the endpoint device 101. The service 105 receives the URL for the web page prior to the web browser 107 requesting web page data from the Internet 109, depicted as request 114 communicated from the endpoint device 101 to the service 105. For instance, the service 105 can be implemented as JavaScript, C, C++, and/or Rust code compiled to a WebAssembly executable file interfacing with the web browser 107, e.g., as a browser extension. Alternatively, the service 105 can be a separate software module and the web browser 107 can be configured to send URLs to the separate software module and wait for a response from the service 105 prior to rendering web pages. The service 105 can be running on virtual machines in the cloud, for instance virtual machines that collectively function as a firewall for the endpoint device 101. In embodiments where the service 105 is running in the cloud, the prefetching of content and CDR based on a malicious verdict(s) can be performed based on receiving the request 114 from the web browser 107 and prior to communicating corresponding HTTP responses to the endpoint device 101. In some embodiments, the service 105 can be running natively in a browser engine for the web browser 107, and the service 105 can detect the request 114 for the web page by the user 103 rather than the endpoint device 101 communicating the request 114 to the service 105.

At stage B, the service 105 communicates an HTTP GET request 100A to the Internet 109 (e.g., to a web server of the web page) to prefetch data for the web page and receives an HTTP response 102A. The service 105 inspects data in the HTTP response 102A, e.g., HTML hyperlink elements (i.e., HTML elements with “<a>” tags), to identify any hyperlinks in the web page. The service 105 then prefetches data for those hyperlinked web pages by communicating HTTP GET requests 100B to the Internet 109 and receiving HTTP responses 102B in response. In some embodiments, the service 105 can prefetch data for the web page using multiple web browser profiles (e.g., by altering the User-Agent request header in an HTTP GET request).

The service 105 generates HTML/JavaScript feature vectors 104 and HTTP header feature vectors 106 for the content classifier 111 and the response classifier 113, respectively. The feature vectors 104, 106 have restricted scope so that the classifiers 111, 113 can identify hyperlinks and sections of source code that are potentially malicious. For instance, the service 105 can extract HTML elements from HTML code in the HTTP responses 102A, 102B to generate the HTML/JavaScript feature vectors 104 (where JavaScript feature vectors are generated from code contained in “<script>” HTML elements). Each of the HTTP header feature vectors 106 is generated from values of HTTP header fields extracted from the HTTP responses 102A, 102B. The service 105 can perform additional preprocessing such as generating natural language processing (NLP) embeddings that preserve semantic similarity to generate the feature vectors 104, 106. The service 105 can, for each feature vector in the feature vectors 104, 106, add an indication of a corresponding HTML element type or HTTP header field, or an indication that the feature vector was generated from JavaScript code. Feature vector generation depends on the architecture and input format for the classifiers 111, 113. For instance, when the classifiers 111, 113 were trained on inputs corresponding to specific HTML element types/HTTP header fields and on inputs preprocessed with NLP, corresponding feature vectors can comprise those HTML elements and HTTP header field values preprocessed with NLP. Each of the feature vectors 104, 106 can be generated with an additional step comprising generating an NLP embedding (e.g., word2vec embeddings, doc2vec embeddings, LLM embeddings, etc.). The classifiers 111, 113 can comprise machine learning classifiers such as random forest classifiers, support vector machines, neural networks, etc.

At stage C, the service 105 inputs the feature vectors 104, 106 into the classifiers 111, 113, respectively, to obtain a malicious verdict(s) 108 as output. Each of the classifiers 111, 113 was trained on feature vectors generated from HTML/JavaScript code and HTTP header fields for known malicious or known benign web pages. Although depicted as individual classifiers, each of the classifiers 111, 113 can comprise multiple classifiers. If the content classifier is implemented as multiple classifiers, the multiple content classifiers can be trained on distinct types of training data. Each type of training data comprises feature vectors for various sections of source code included in HTTP responses. For instance, a classifier can be trained on feature vectors for specific HTML elements, e.g., paragraph HTML elements, on feature vectors of JavaScript code for known malicious attacks, on feature vectors of specific HTTP header fields, etc. Each of the classifiers 111, 113 may receive multiple of the feature vectors 104, 106 as input to obtain multiple malicious or benign verdicts. For instance, a classifier for hyperlinks/URLs may receive a URL for each hyperlinked web page as input, a classifier for HTML paragraph elements may receive a feature vector for each HTML paragraph element as input, a JavaScript code classifier may receive a feature vector for each HTML script element comprising JavaScript code as input, etc.

For a classifier with many internal parameters, that classifier can be trained on multiple types of training data and training data across HTTP header fields, JavaScript code or other executable code, HTML documents, etc. In some embodiments, the classifiers 111, 113 can comprise classifiers that take feature vectors generated from entire HTTP responses and is used to classify each of the hyperlinked web pages in the HTTP responses 102B. The classifiers 111, 113 can comprise third party classifiers such as services that generate verdicts for URLs, in which case the corresponding feature vector is a URL or other identifier of a hyperlinked web page.

The service 105 obtains malicious verdict(s) 108 and indications of corresponding HTTP header fields, JavaScript code, or HTML code as output of the classifiers 111, 113 from inputting the feature vectors 104, 106, respectively. If the classifiers 111, 113 do not output any malicious verdicts, the service 105 omits the subsequent CDR operations described in reference to FIG. 1 and communicates the HTTP response 102A to the web browser 107 for rendering.

At stage D, the service 105 performs CDR on the HTTP response 102A to remove source code based on the malicious verdict(s) 108 and reconstructs the remaining source code to obtain HTTP response 102C. The service 105 applies criteria to the malicious verdict(s) 108 to determine whether to block the web page, disable malicious hyperlinks in the web page, and/or remove source code in the web page. If a number of the malicious verdict(s) 108 is above a threshold, one or more of the malicious verdict(s) 108 are above a threshold severity, and/or the malicious verdict(s) 108 correspond to highly sensitive source code, the service 105 communicates an HTTP response to the web browser 107 indicating that the web page is blocked and, optionally, metadata for determining that the web page should be blocked such as a cybersecurity attack type, attack severity, etc.

If the service 105 doesn't block the web page, then the service 105 applies additional criteria to determine whether to disable hyperlinks in the HTTP response 102A and/or remove source code from the HTTP response 102A. For each malicious verdict(s) 108, if the verdict corresponds to a hyperlink element and/or a hyperlinked web page, the service 105 disables the hyperlink corresponding to that corresponding hyperlink element and/or crawled web page. For instance, the service 105 can remove the corresponding hyperlink HTML element and add an HTML element in its place indicating that the hyperlink was disabled and optionally including an indication of the corresponding malicious verdict and metadata of the verdict (e.g., severity, attack type, etc.).

For the remaining of the malicious verdict(s) 108 that correspond to malicious code, the service 105 identifies corresponding sections of source code in the HTTP responses 102A. The service 105 removes those sections of source code and reconstructs the remaining source code as the HTTP response 102C. Reconstruction of the source code comprises adding indications of content removed (e.g., by adding visual elements to the HTTP response 102C that indicate blackout for sections of the web page that were removed), adding indications of hyperlinks that were disabled and reasons for the disabling. When a malicious attack corresponding to a hyperlinked web page comprises a phishing attack, the service can search a database of known/trusted web page URLs for a trusted URL most similar to the URL of the hyperlinked web page (e.g., based on semantic similarity) and replace the malicious hyperlink with the trusted hyperlink.

The service 105 then communicates the HTTP response 102C to the web browser 107 for rendering. The web browser 107 maintains a prefetching cache 110 with data from the HTTP response 102C (or the HTTP responses 102A when there were no malicious verdicts). The prefetching cache 110 also stores the malicious verdict(s) 108 so that when the user 103 requests additional web pages, the web browser 107 can block those web pages or render those web pages with source code removed/disabled without having to crawl the web pages and generate verdicts via the service 105.

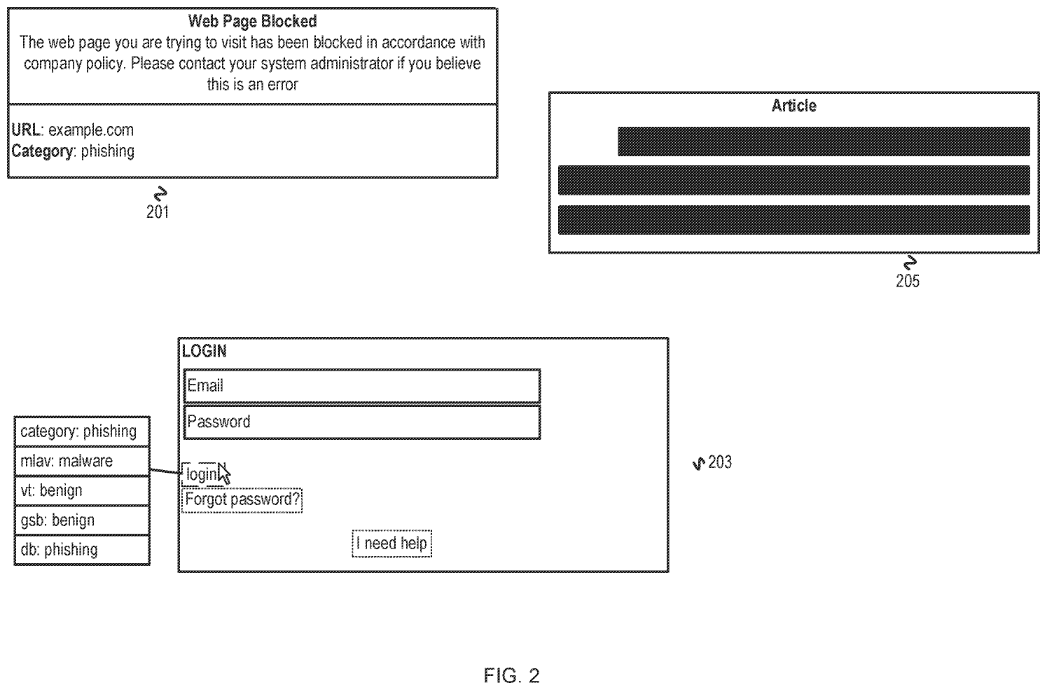

FIG. 2 is an illustrative diagram of example web page renders after a web browser CDR service (“service”) performs a disarm action. A disarm action may be blocking a web page, removing content from the web page, and/or disabling content (e.g., hyperlinks) in the web page. The service causes a web browser to generate web page render 201 when the service blocks a requested web page. The web page render 201 indicates the text “Web Page Blocked . . . The web page you are trying to visit has been blocked in accordance with company policy. Please contact your system administrator if you believe this is an error”. The web page render 201 also indicates the requested URL “example.com” and that the reason for blocking the web page was a phishing attack. Web page render 203 comprises a login page. The service added outlines to hyperlinks in the existing login page labelled “login”, “Forgot password?”, and “I need help” to indicate these hyperlinks were disabled during CDR. When a mouse icon hovers above an element corresponding to a disabled hyperlink, the web page render 203 updates the user interface to indicate a cybersecurity attack category for the hyperlink. The web page render 203 is updated to indicate phishing for the “login” hyperlink, a verdict from a machine learning model enforcing antivirus on a firewall of malicious, a VirusTotal® URL scan verdict of benign, a Google Safe Browsing® API verdict of benign, and a database verdict of phishing. A web browser generates web page render 205 when the service removes source code corresponding to content in an article of the web page and indicates black bars where content was removed. Alternatively, the service can remove source code not directly displayed on the web page (e.g., JavaScript code for an injection attack that exploits endpoint device computing resources while browsing the web page). Although the web page render 205 displays all content as being removed, in other embodiments the service can remove specific sections of content/source code corresponding to specific malicious verdicts.

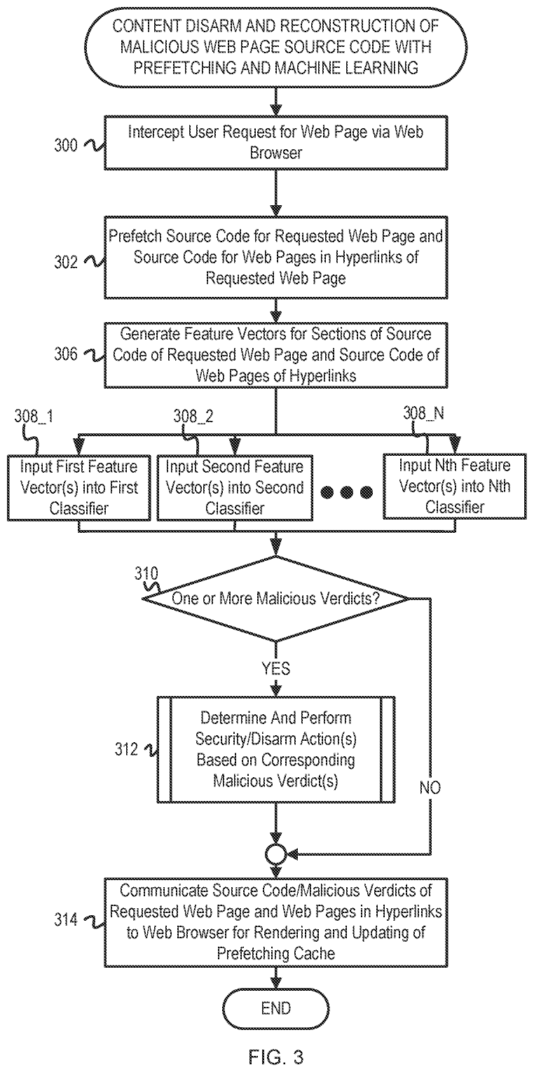

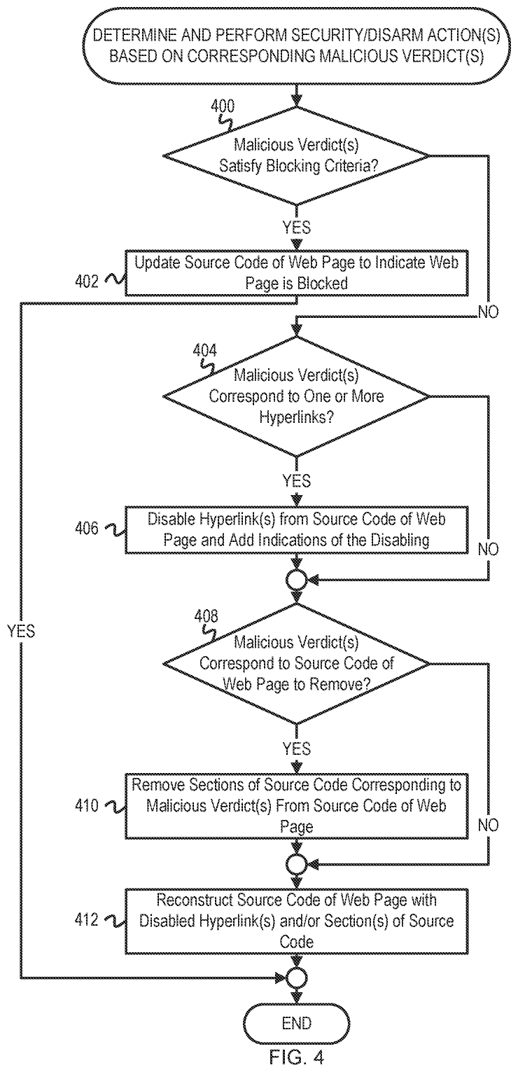

FIGS. 3 and 4 are flowcharts of example operations for blocking web pages and/or removing/disabling source code in web pages based on malicious verdicts for sections of source code using prefetching. The example operations are described with reference to a web browser CDR service (“service”) and classifiers for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for CDR of malicious web page source code with prefetching and machine learning. At block 300, the service intercepts a user request for a web page initiated at a web browser. For instance, the service can be running on a firewall (e.g., a cloud firewall) managing network security for an endpoint device running the web browser. Alternatively, the service can be running natively on a web browser engine or as a web browser extension. The service can be compiled from a WebAssembly file to facilitate interactions between the service and the web browser.

At block 302, the service prefetches source code for the requested web page and source code for web pages in hyperlinks of the requested web page. The service communicates an HTTP GET request for the requested web page and inspects a corresponding HTTP response to identify hyperlinks. If the service identifies any hyperlinks in the HTTP response, the service then communicates additional HTTP GET requests for web pages corresponding to the identified hyperlinks and receives additional HTTP responses.

At block 306, the service generates feature vectors for sections of source code of the requested web page and source code of any web page for any identified hyperlinks. The service can generate the feature vectors as NLP embeddings of sections of source code. Sections of source code can vary by scope of training data used to train corresponding classifiers. For instance, when a classifier was trained on entire HTML documents, a feature vector can comprise NLP embeddings of full HTML documents included in HTTP responses for each web page. Alternatively, a classifier can be trained on feature vectors of specific types of HTML elements, JavaScript code, or specific HTTP header fields, and the corresponding generated feature vectors can comprise NLP embeddings of HTML elements, JavaScript code, and HTTP header field values, respectively. Hyperlink HTML elements correspond to separate feature vectors, and in some embodiments, there is a separate feature vector for each HTTP header field value, each HTML element, and each script of JavaScript code.

At blocks 308_1-308_N, the service inputs the feature vectors into respective classifiers to obtain verdicts. Each block corresponds to a distinct classifier, and each classifier at each block can receive one or more feature vectors. For instance, a classifier of hyperlinks may receive a feature vector for each hyperlink HTML element in the requested web page, a classifier of JavaScript code may receive multiple script HTML elements, etc. Additionally, each feature vector may be communicated to multiple classifiers, for instance when multiple classifiers are used to detect malicious URLs to reduce false negative benign verdicts. Certain classifiers may receive feature vectors for specific combinations of HTML elements, HTTP response header fields, etc. that are known to be important for malicious web page detection. As an example, for a classifier of HTTP header field values, the classifier may receive a feature vector of HTTP header field values for a HTTP Content-Security-Policy header field, an HTTP X-Content-Type-Options header field, an HTTP Referrer-Policy header field, and any other HTTP header fields known to be effective/accurate for predicting malicious activity. The classifiers described above are content classifiers of HTTP header feature vectors and content classifiers of HTML/JavaScript feature vectors as an illustrative example. In general, classifiers can be trained to classify any sections of code extracted from HTTP responses. The verdicts indicate whether corresponding sections of source code (e.g., the various example sections of code described above) are malicious or benign. The classifiers can comprise machine learning classifiers such as neural networks, support vector machines, etc. The classifiers can be configured to output a type of malicious attack for a malicious verdict, a severity of the attack etc.

At block 310, the service determines whether one or more of the verdicts are malicious. If there are one or more malicious verdicts, operational flow proceeds to block 312. Otherwise, operational flow skips to block 314.

At block 312, the service determines and performs a security/disarm action(s) based on the corresponding malicious verdict(s). The operations at block 312 are described in greater detail in reference to FIG. 4.

At block 314, the service communicates the source code and any malicious verdict for the requested web page and the hyperlinked web pages to a web browser for rendering and updating of a prefetching cache. The prefetching cache stores source code and malicious verdicts so that when the user requests additional web pages, the web browser can either block or render web pages after CDR is applied without having to recrawl the Internet and perform CDR with the service according to the foregoing operations in FIG. 3. For instance, when the web browser receives additional requests for web pages, the web browser and/or service can search the prefetching cache to see if the requested web pages correspond to malicious verdicts in the prefetching cache and automatically block those web pages or replace HTTP responses for those web pages with versions of those HTTP responses stored in the prefetching cache having CDR previously applied.

FIG. 4 is a flowchart of example operations for determining and performing a security/disarm action(s) based on a corresponding malicious verdict(s). Security/disarm actions comprise removing/disabling malicious source code/hyperlink(s) and/or blocking a web page based on a corresponding malicious verdict(s). The operations in FIG. 4 assume that a malicious verdict(s) has been previously obtained for a web page requested by a user based on crawling the requested web page and any web pages hyperlinked in the requested web page (hereafter “web page”) and classifying source code obtained from the crawling. Each malicious verdict corresponds to a section of source code. Malicious verdicts generated from content classifiers (i.e., HTML/JavaScript/CSS code classifiers) can correspond to hyperlinks, malicious content/code, and/or both. For instance, malicious verdict of content/code contained in hyperlinks or malicious verdicts for hyperlink HTML elements correspond to hyperlinks. A malicious verdict for content that includes a hyperlink element(s) corresponds to both the content (resulting in removal of the content) and the hyperlink element (resulting in disabling of the hyperlink element(s)).

At block 400, the service determines whether the malicious verdict(s) satisfies criteria for blocking the web page. The criteria can comprise that there are a threshold number of malicious verdicts, that one or more of the malicious verdict(s) have a threshold severity, a combination of those criteria, etc. If the malicious verdict(s) satisfies the blocking criteria, operational flow proceeds to block 402. Otherwise, operational flow proceeds to block 404.

At block 402, the service updates the source code of the requested web page to indicate that the web page is blocked. For instance, the service can discard source code of the requested web page and replace it with template source code of a blocked web page populated with fields indicating a type of cybersecurity attack, and URL of the web page, etc. The operational flow in FIG. 4 terminates.

At block 404, the service determines whether the malicious verdict(s) corresponds to one or more hyperlinks. Each malicious verdict indicates a corresponding section of source code for either the web page or web pages hyperlinked in the web page. The service can determine whether the section(s) of source code corresponding to the malicious verdict(s) corresponds to source code of a hyperlinked web page or includes a hyperlink HTML element. If the service determines that the malicious verdict(s) corresponds to one or more hyperlinks, operational flow proceeds to block 406. Otherwise, operational flow skips to block 408.

At block 406, the service disables a hyperlink(s) from source code of the web page and adds an indication of the disabling. The disabled hyperlink(s) comprise one or more hyperlinks determined to correspond to a malicious verdict. In other embodiments, the service can analyze the malicious verdict(s) associated with hyperlinks to determine whether each hyperlink should be disabled, for instance using similar criteria for when determining whether the web page should be blocked. Disabling of the hyperlink(s) can comprise replacing a hyperlink HTML element with a paragraph HTML element containing the text of the hyperlink or removing the hyperlink HTML element entirely.

At block 408, the service determines whether any of the malicious verdict(s) correspond to source code of the web page to be removed. For instance, the service can identify all sections of source code associated with a malicious verdict for removal except for source code solely relating to a hyperlink. Source code of the web page at this block refers to source code of the web page that may include a hyperlink. For instance, a malicious verdict for HTML elements of the web page that include a hyperlink HTML element and additional (non-hyperlink) HTML elements comprises source code of the web page. As such, in some embodiments a malicious verdict can correspond to both one or more hyperlinks and source code of the web page. If one or more malicious verdicts correspond to source code of the web page, operational flow proceeds to block 410. Otherwise, operational flow skips to block 412.

At block 410, the service removes sections of source code corresponding to the malicious verdict(s) from source code of the web page. In some embodiments, the service can remove full sections of source code from the web page whereas in other embodiments, the service can selectively remove subsections of source code. For instance, the service can sanitize sections of source code by removing potentially malicious JavaScript code but keep content in HTML elements. When only a subsection of source code is matched with a signature in a database, the service can only remove that subsection.

At block 412, the service reconstructs the source code of the web page with the disabled hyperlink(s) and/or removed section(s) of source code. For disabled hyperlinks, the service can highlight the corresponding hyperlink HTML element and/or add functionality to the source code of the web page so that when a cursor hovers of the highlighted element or other UI option is enabled/clicked, details of the disabled hyperlink (e.g., a cybersecurity attack type) appear in the rendered web page. When the disabled hyperlink is for a phishing attack, the service can perform a lookup for a hyperlink with a semantically similar URL to the URL of the disabled hyperlink from a database of known/trusted URLs and replace the disabled hyperlink with the known/trusted URL in the reconstructed web page. For removed malicious code/content, the service can add indications of the removed malicious code/content such as visual elements that blackout the removed malicious code/content and descriptions of what was removed and why. The service can also add attack types for each malicious verdict and a service(s) that made the malicious verdict.

### Variations

Various feature vectors input to corresponding classifiers to obtain malicious/benign verdicts of web page source code are described as feature vectors for sections of HTML documents, JavaScript code, and HTTP responses. Alternatively, any data returned from prefetching source code for a web page via the Internet can be used for feature vector generation, e.g., CSS code. Feature vectors can be generated from source code in multiple programming languages and/or at multiple locations in HTTP responses. The term “prefetching” can refer to prefetching performed by a separate service (e.g., the web browser CDR services described in the foregoing) from a web browser or can be running natively in a web browser, e.g., as a browser extension. In some embodiments, the web browser may not be aware than any prefetching/CDR is occurring.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in blocks 404, 406, 408, and 410 can be performed in parallel or concurrently across malicious verdicts. It will be understood that each block of the flowchart illustrations and/or block diagrams, and combinations of blocks in the flowchart illustrations and/or block diagrams, can be implemented by program code. The program code may be provided to a processor of a general-purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

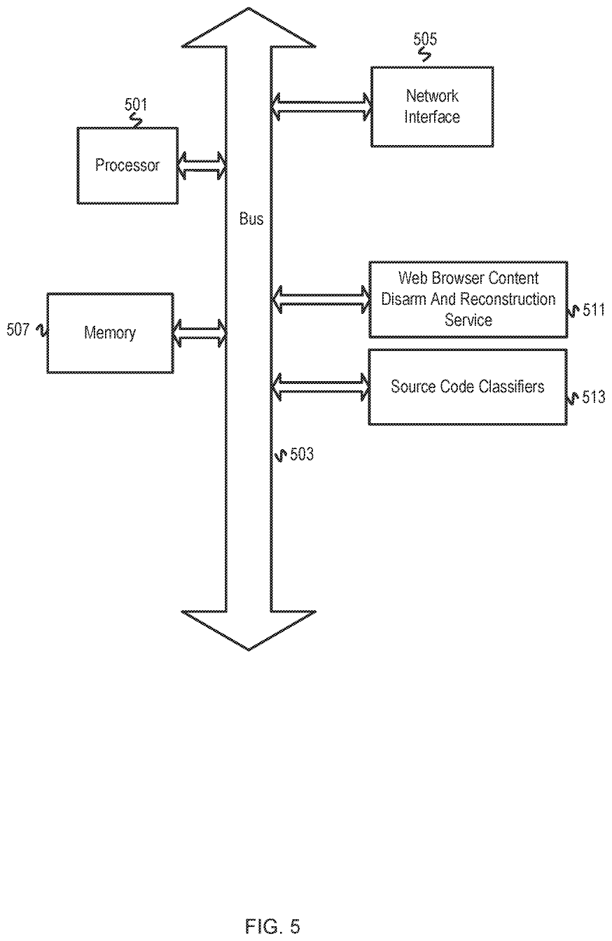

FIG. 5 depicts an example computer system with a web browser CDR service and source code classifiers. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a web browser CDR service 511 (“service”) and source code classifiers 513. The service 511 intercepts a user request for a web page via a web browser. The service 511 then prefetches source code for the requested web page and any web pages hyperlinked in the requested web page. The service 511 generates feature vectors based on sections of the source code for inputting into the source code classifiers 513. Each section can comprise HTML elements, JavaScript code, HTTP header field values, etc. The source code classifiers 513 receive respective feature vectors generated by the service 511 and output corresponding verdicts. The service 511 applies criteria to any malicious verdicts to determine whether to block the web page or remove malicious code and/or disable hyperlinks from the source code of the web page. If the service 511 removed malicious code and/or disabled hyperlinks from the source code of the web page, the service 511 then reconstructs the source code of the web page. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor 501 and the network interface 505 are coupled to the bus 503. Although illustrated as being coupled to the bus 503, the memory 507 may be coupled to the processor 501.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method for removing potentially malicious code from a first web page prior to rendering the first web page, the method comprising:
prefetching first source code for the first web page;
identifying one or more hyperlinks to one or more second web pages in the first source code;
prefetching second source code for the one or more second web pages;
generating one or more first feature vectors of the first source code and one or more second feature vectors of the second source code, wherein the one or more first feature vectors and the one or more second feature vectors correspond to potentially malicious subsets of source code;
inputting the one or more first feature vectors and one or more second feature vectors into one or more classifiers to obtain verdicts of the one or more first feature vectors and the one or more second feature vectors as output; and
removing a subset of the first source code to obtain third source code, wherein the subset of the first source code corresponds to at least one of a subset of the one or more first feature vectors and a subset of the one or more second feature vectors having malicious verdicts output by at least a subset of the one or more classifiers.

2. The method of claim 1, wherein the one or more first feature vectors and the one or more second feature vectors comprise feature vectors of at least one of HyperText Markup Language (HTML) code, JavaScript code, Cascading Style Sheets (CSS) code, and one or more HyperText Transfer Protocol (HTTP) responses from prefetching the first source code and prefetching the second source code.

3. The method of claim 1 further comprising reconstructing the third source code.

4. The method of claim 3, wherein reconstructing the third source code comprises reconstructing the third source code with indications of removal of the subset of the first source code.

5. The method of claim 1, further comprising blocking the first web page based, at least in part, on the verdicts of the one or more first feature vectors and the one or more second feature vectors.

6. The method of claim 1, wherein the one or more classifiers comprise machine learning classifiers.

7. The method of claim 1, further comprising disabling one or more hyperlinks for the first web page based, at least in part, on the verdicts of the one or more second feature vectors.

8. A non-transitory machine-readable medium having program code stored thereon, the program code comprising instructions to:
prefetch first source code for a first web page and second source code for one or more second web pages indicates in hyperlinks of the first web page;
generate one or more first feature vectors of the first source code and one or more second feature vectors of the second source code, wherein the one or more first feature vectors and the one or more second feature vectors correspond to potentially malicious subsets of source code;
input the one or more first feature vectors and one or more second feature vectors into one or more classifiers to obtain verdicts of the one or more first feature vectors and the one or more second feature vectors as output; and
based, at least in part, on one or more malicious verdicts in the verdicts output by the one or more classifiers, at least one of block the first web page, remove malicious source code from the first source code, and disable hyperlinks in the first source code to obtain third source code.

9. The non-transitory machine-readable medium of claim 8, wherein the one or more first feature vectors and the one or more second feature vectors comprise feature vectors of at least one of HyperText Markup Language (HTML) code, JavaScript code, Cascading Style Sheets (CSS) code, and one or more HyperText Transfer Protocol (HTTP) responses from prefetching the first source code and prefetching the second source code.

10. The non-transitory machine-readable medium of claim 8, wherein the program code further comprises instructions to reconstruct the third source code.

11. The non-transitory machine-readable medium of claim 10, further comprising program code to store indications of the third source code and the one or more malicious verdicts in a prefetching cache.

12. The non-transitory machine-readable medium of claim 10, wherein the program code to reconstruct the third source code comprises instructions to reconstruct the third source code with indications of at least one of blocking the first web page, removing malicious code from the first web page, and disabling hyperlinks in the first web page.

13. The non-transitory machine-readable medium of claim 8, wherein the one or more classifiers comprise machine learning classifiers.

14. An apparatus comprising:
a processor; and
a machine-readable medium having instructions stored thereon that are executable by the processor to cause the apparatus to,
prefetch first source code for a first web page and second source code for one or more second web pages indicates in hyperlinks of the first web page;
generate one or more first feature vectors of the first source code and one or more second feature vectors of the second source code, wherein the one or more first feature vectors and the one or more second feature vectors correspond to potentially malicious subsets of source code;
input the one or more first feature vectors and one or more second feature vectors into one or more classifiers to obtain verdicts of the one or more first feature vectors and the one or more second feature vectors as output; and
based, at least in part, on one or more malicious verdicts in the verdicts output by the one or more classifiers, at least one of block the first web page, remove malicious source code from the first source code, and disable hyperlinks in the first source code to obtain third source code.

15. The apparatus of claim 14, wherein the one or more first feature vectors and the one or more second feature vectors comprise feature vectors of at least one of HyperText Markup Language (HTML) code, JavaScript code, Cascading Style Sheets (CSS) code, and one or more HyperText Transfer Protocol (HTTP) responses from prefetching the first source code and prefetching the second source code.

16. The apparatus of claim 14, wherein the machine-readable medium further has stored thereon instructions executable by the processor to cause the apparatus to reconstruct the third source code.

17. The apparatus of claim 16, wherein the machine-readable medium further has stored thereon instructions executable by the processor to cause the apparatus to store indications of the third source code and the one or more malicious verdicts in a prefetching cache.

18. The apparatus of claim 16, wherein the instructions to reconstruct the third source code comprises comprise instructions executable by the processor to cause the apparatus to reconstruct the third source code with indications of at least one of blocking the first web page, removing malicious code from the first web page, and disabling hyperlinks in the first web page.

19. The apparatus of claim 16, further comprising communicating the third source code to a web browser for rendering.

20. The apparatus of claim 14, wherein the one or more classifiers comprise machine learning classifiers.
